(19) United States
(12) Patent Application Publication
(10) Pub. No.: US 2006/0139542 A1
(43) Pub. Date: Jun. 29, 2006

(54) Vertical alignment liquid crystal display device

(75) Inventors: Shinya Ando, Tokyo (JP); Yasushi Nakajima, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/311,679

(22) Filed: Dec. 19, 2005

(30) Foreign Application Priority Data
Dec. 24, 2004 (JP) 2004-375019

(51) Int. Cl. G02F 1/1337

(52) U.S. Cl. 349/130

(57) ABSTRACT

A liquid crystal display device has rear and front substrates having pixel electrodes and an opposing electrode formed on their opposing inner surfaces respectively, vertical alignment films formed on their opposing inner surfaces respectively, and a liquid crystal layer disposed between the vertical alignment films and having negative dielectric anisotropy. Protrusions are formed on the inner surface of the front substrate, at a position adjoining one edge of each of the pixel electrodes formed on the inner surface of the rear substrate, correspondingly to a position about the center of the one edge of the pixel electrode. The vertical alignment film on the inner surface of the rear substrate is rubbed in a direction from an edge opposite to the one edge of the pixel electrode adjoining the protrusion toward the one edge. The vertical alignment film on the inner surface of the front substrate is rubbed in reverse direction.

### BACKGROUND OF THE INVENTION

1. Field of the Invention

The present invention relates to a vertical alignment active matrix liquid crystal display device using a thin film transistor (hereinafter referred to as TFT) as an active element.

2. Description of the Related Art

A vertical alignment liquid crystal display device comprises a pair of substrates opposite to each other with a predetermined gap therebetween, a plurality of pixel electrodes arranged in a matrix of rows and columns on the inner surface of one substrate of the opposing inner surfaces of the pair of substrate, a plurality of TFTs arranged on the inner surface of the one substrate correspondingly to the plurality of pixel electrodes and connected to the corresponding pixel electrodes, a plurality of gate lines and data lines formed on the inner surface of the one substrate respectively between the rows of pixel electrodes and the columns of pixel electrodes for supplying a gate signal and a data signal to the TFTs on the corresponding rows and columns, an opposing electrode formed on the inner surface of the other substrate so as to oppose to each of the plurality of pixel electrodes, vertical alignment films formed so as to cover the electrodes on the inner surfaces of the front substrate and rear substrate respectively, and a liquid crystal layer having a negative dielectric anisotropy filled in the gap between the front substrate and the rear substrate.

The vertical alignment liquid crystal display device displays an image by aligning liquid crystal molecules being in the vertically aligned state to lie down by applying a voltage between each of the pixel electrodes and the opposing electrode, in each of a plurality of pixels that are defined in the areas where the plurality of pixel electrodes and the opposing electrode face each other. As the voltage is applied, the liquid crystal molecules in each pixel are so aligned as to lie down to the substrate.

Such a vertical alignment liquid crystal display device causes variation in the state of lying alignment of the liquid crystal molecules in accordance with the voltages applied to the respective pixels, resulting in display unevenness.

Hence, in order to stabilize the alignment state of each pixel and obtain a wider view angle characteristic, it is proposed to form a plurality of domains where the liquid crystal molecules are aligned along plural directions pixel by pixel. For instance, as described in the specification of Japanese Patent Publication No. 2565639, a liquid crystal display apparatus proposed has the opposing electrode formed with a slit with the shape of a letter X, so that the liquid crystal molecules in each pixel are so aligned as to tilt toward the center of the X-shaped slit along the four directions when a voltage is applied between the two electrodes facing each other.

However, since it is required in this liquid crystal display device that the domains be formed which has different alignment directions from each other due to the X-shaped slit formed in each pixel, the X-shaped slit needs to be formed to have a sufficiently large width in order to prohibit the interaction between the domains. This increases the area of the slit, which is not controllable by electric fields, in each pixel, thereby reduces the area where the opposing electrode and the pixel electrode face each other, resulting in a low aperture ratio.

### SUMMARY OF THE INVENTION

An object of the present invention is to provide a vertical alignment active matrix liquid crystal display device which can achieve bright display and a wide view angle with no display unevenness, and can display an image of a high-quality by aligning the liquid crystal molecules in each pixel stably into the lying alignment by applying a voltage.

To achieve the above object, a liquid crystal display device according to a first aspect of the present invention comprises:

a pair of substrates which are opposite to each other with a predetermined gap therebetween;

at least one opposing electrode which is formed on an inner surface of one substrate of opposing inner surfaces of the pair of substrates;

a plurality of pixel electrodes which are arranged in a matrix of a row direction and a column direction on an inner surface of the other substrate of the opposing inner surfaces of the pair of substrates, each define a pixel in an area where each faces the opposing electrode, and each have a shape of substantially a rectangle;

a plurality of protrusions which are formed on the inner surface of either one substrate of the pair of substrates so as to each adjoin one edge, which is one of two opposing edges of each of the plurality of pixel electrodes, and so as to correspond to a position about a center of length of the one edge;

a first vertical alignment film which is formed on the inner surface of the one substrate and rubbed in a direction heading from the one edge of the pixel electrode adjoining the protrusion toward the other edge opposite to the one edge;

a second vertical alignment film which is formed on the inner surface of the other substrate and rubbed in a direction reverse to the rubbing direction of the first vertical alignment film; and

a liquid crystal layer which is filled in the gap between the pair of substrates and has a negative dielectric anisotropy.

The liquid crystal display device according to the first aspect of the invention can align the liquid crystal molecules in each pixel into an orderly lying alignment in redetermined lying directions defined by the rubbing directions of the vertical alignment films and by a liquid crystal molecule alignment direction around the protrusions when a voltage is applied between the pixel electrodes and the opposing electrode, and thus can display an image of a high-quality.

In the present liquid crystal display device, it is preferred that the plurality of protrusions be formed on the inner surface of one substrate on which the opposing electrode is formed. In this case, it is preferred that the first vertical alignment film be formed so as to cover the opposing electrode and the protrusions which are formed on the inner surface of the one substrate, and be rubbed in a direction heading from the one edge of the pixel electrode formed on the other substrate that adjoins the protrusion toward the other edge opposite to the one edge, and the second vertical alignment film be formed so as to cover the plurality of pixel electrodes formed on the inner surface of the other substrate, and be rubbed in a direction reverse to the rubbing direction of the first vertical alignment film.

Further, it is preferred that the plurality of protrusions are each formed so as to have heir one part face the one edge of each of the plurality of pixel electrodes formed on the other substrate, and that the protrusions be made of a dielectric material.

It is preferred that the present liquid crystal display device further comprise: a plurality of thin film transistors which are formed on the inner surface of the other substrate so as to correspond to the plurality of pixel electrodes respectively, and are connected to the corresponding pixel electrodes respectively; and a plurality of gate lines and data lines which are formed between rows and columns of the plurality of pixel electrodes respectively, for supplying a gate signal and a data signal to the thin film transistors on the corresponding rows and columns.

In this case, it is preferred that the protrusions be each formed on the inner surface of the one substrate at a position which adjoins the one edge, to which the thin film transistor is connected, of each of the plurality of pixel electrodes, and which corresponds to the position about the center of length of the one edge.

In the present liquid crystal display device, it is preferred that the plurality of protrusions have a height of protrusion for setting a liquid crystal layer thickness to a predetermined thickness, and the gap between the pair of substrates be defined by ends of the plurality of protrusions abutting on the inner surface of the other substrate. With this structure, the thickness of the liquid crystal layer in each pixel can be made uniform, thereby enabling a high-quality image with no luminance unevenness to be displayed, and the liquid crystal display device to be manufactured easily.

Furthermore, it is preferred that the present liquid crystal display device comprise an auxiliary electrode which is formed on the inner surface of the other substrate along edges of each of the plurality of pixel electrodes except a portion of the one edge adjoining the thin film transistor in a peripheral region of the pixel electrode, in order to form a region between the auxiliary electrode and the opposing electrode on the one substrate to which region substantially no electric field is applied. In this case, it is preferred that the auxiliary electrode be formed integrally with a compensating-capacitor electrode for forming a compensating capacity between the compensating-capacitor electrode and the pixel electrode. Having this structure, the liquid crystal display device can have a sufficient aperture ratio.

It is further preferred that a plurality of thin film transistors be formed on the inner surface of the other substrate so as to correspond to the plurality of pixel electrodes respectively and so as to be connected to the corresponding pixel electrodes respectively, wherein the thin film transistors are each formed on a position about a center of the one edge of each of the plurality of pixel electrodes.

According to the present liquid crystal display device, the lying directions of the liquid crystal molecules in each pixel when a voltage is applied between the pixel electrode and the opposing electrode are defined by the rubbing directions of the vertical alignment films, a lateral field generated between the gate electrode of the thin film transistor and the pixel electrode, and level differences in the thin film transistor, which enables the liquid crystal display device to obtain a stable state of alignment and display a high-quality image.

In this case, it is preferred that the first vertical alignment film be formed on the inner surface of the one substrate so as to cover the opposing electrode and be rubbed in a direction heading from the one edge, to which the thin film transistor is connected, of the pixel electrode formed on the other substrate toward the other edge opposite to the one edge, and the second vertical alignment film be formed on the inner surface of the other substrate so as to cover the plurality of pixel electrodes and the plurality of thin film transistors, and be rubbed in a direction reverse to the rubbing direction of the first vertical alignment film.

A liquid crystal display device according to a second aspect of the present invention comprises:

a pair of substrates which are opposite to each other with a predetermined gap therebetween;

at least one opposing electrode which is formed on an inner surface of one substrate of opposing inner surfaces of the pair of substrates;

a plurality of pixel electrodes which are formed in a matrix of a row direction and a column directions on an inner surface of the other substrate of the opposing inner surfaces of the pair of substrates, and each define a pixel in an area where each faces the opposing electrode;

a plurality of thin film transistors which are formed on the inner surface of the other substrate so as to correspond to the plurality of pixel electrodes respectively, and are connected to the corresponding pixel electrodes respectively;

a plurality of gate lines and data lines which are formed on the inner surface of the other substrate between rows and columns of the plurality of pixel electrodes, for supplying a gate signal and a data signal to the thin film transistors on the corresponding rows and columns;

a plurality of protrusions which are each formed on the inner surface of the one substrate at a position which adjoins either of one edge, to which the thin film transistor is connected, of each of the plurality of pixel electrodes and the other edge opposite to the one edge, and which position corresponds to a position about a center of length of the either of the edges;

a first vertical alignment film which is formed on the inner surface of the one substrate so as to cover the opposing electrode and the protrusions, and is rubbed in a direction heading from the one edge, which adjoins the protrusion, of the pixel electrode formed on the other substrate toward the other edge opposite to the one edge;

a second vertical alignment film which is formed on the inner surface of the other substrate so as to cover the plurality of pixel electrodes, and is rubbed in a direction reverse to the rubbing direction of the first vertical alignment film; and

a liquid crystal layer which is filled in the gap between the pair of substrates and has a negative dielectric anisotropy.

The liquid crystal display device according to the second aspect of the invention can align the liquid crystal molecules in each pixel into an orderly lying alignment in predetermined lying directions defined by the rubbing directions of the vertical alignment films and by a liquid crystal molecule alignment direction around the protrusions when a voltage is applied between the pixel electrodes and the opposing electrode, and thus can display an image of a high-quality.

In the present liquid crystal display device, it is preferred that the pixel electrode be formed in a shape of a rectangle, and the plurality of protrusions be each formed on the inner surface of the one substrate at a position which adjoins the one edge, to which the thin film transistor is connected, of each of the plurality of pixel electrodes on the other substrate, and which position corresponds to a position about the center of length of the one edge.

It is preferred that the protrusions be each formed at a position at which part of each protrusion overlaps the gate line formed between rows of a plurality of pixel electrodes and the one edge of the pixel electrode.

It is further preferred that the plurality of protrusions have a height of protrusion for setting a liquid crystal layer thickness to a predetermined thickness, and the gap between the pair of substrates be defined by ends of the plurality of protrusions abutting on the inner surface of the other substrate.

It is further preferred that the liquid crystal display device further comprise an auxiliary electrode which is formed on the inner surface of the other substrate along edges of each of the plurality of pixel electrodes except a portion of the one edge adjoining the thin film transistor in a peripheral region of the pixel electrode, in order to form a region between the auxiliary electrode and the opposing electrode on the one substrate to which region substantially no electric field is applied. In this case, it is preferred that the auxiliary electrode be formed integrally with a compensating-capacitor electrode for forming a compensating capacity between the compensating-capacitor electrode and the pixel electrode. With this structure, a sufficient aperture ratio can be obtained.

A liquid crystal display device according to a third aspect of the present invention comprises:

a pair of substrates which are opposite to each other with a predetermined gap therebetween;

at least one opposing electrode which is formed on an inner surface of one substrate of opposing inner surfaces of the pair of substrates;

a plurality of pixel electrodes which are formed in a matrix of a row direction and a column direction on an inner surface of the other substrate of the opposing inner surfaces of the pair of substrates, which each have a shape of a rectangle having one edge of its two opposing edges formed to be a V-shaped edge having substantially a V-character shape obtained by obliquely cutting the one edge from a center of the one edge toward both sides, and which each define a pixel in an area where each faces the opposing electrode;

a plurality of thin film transistors which are each formed on the inner surface of the other substrate so as to correspond to the other edge of each of the plurality of pixel electrodes that is opposite to the V-shaped edge, and which are each connected to the corresponding pixel electrode;

a plurality of gate lines and data lines which are formed on the inner surface of the other substrate between rows and columns of the plurality of pixel electrodes, for supplying a gate signal and a data signal to the thin film transistors on the corresponding rows and columns;

a first vertical alignment film which is formed on the inner surface of the one substrate so as to form the opposing electrode and is rubbed in a direction heading from the other edge opposite to the V-shaped edge of the pixel electrode formed on the other substrate toward the V-shaped edge;

a second vertical alignment film which is formed on the inner surface of the other substrate so as to cover the plurality of pixel electrodes, and is rubbed in a direction reverse to the rubbing direction of the first vertical alignment film; and

a liquid crystal layer which is filled in the gap between the pair of substrates and has a negative dielectric anisotropy.

According to the liquid crystal display device of the third aspect of the invention, the lying directions of the liquid crystal molecules in each pixel are defined by the rubbing directions of the vertical alignment films and by a liquid crystal molecule alignment direction near the V-shaped edge of the pixel electrode when a voltage is applied between the pixel electrodes and the opposing electrode, enabling the liquid crystal display device to obtain a stable state of alignment and display an image of a high-quality.

In the present liquid crystal display device, it is preferred that edge portions on the both sides of the V-shaped edge of the pixel electrode be formed to be inclined with respect to the rubbing directions of the first and second vertical alignment films at an angle of 45°±15°, respectively. With this structure, the lying directions of the liquid crystal molecules in each pixel can more securely be defined when a voltage is applied.

### BRIEF DESCRIPTION OF THE DRAWINGS

These objects and other objects and advantages of the present invention will become more apparent upon reading of the following detailed description and the accompanying drawings in which:

FIG. 1 is a plan view of one pixel on one substrate of a liquid crystal display device as the first embodiment of the present invention;

FIG. 2 is a cross sectional view of the liquid crystal display device of FIG. 1 as cut along a line II-II;

FIG. 3 is a cross sectional view of the liquid crystal display device of FIG. 1 as cut along a ling III-III;

FIG. 4 is a plan view showing a state of alignment of liquid crystal molecules in one pixel of the liquid crystal display device of the first embodiment when a voltage is applied thereto;

FIG. 5 is a cross sectional view showing a state of alignment of liquid crystal molecules in one pixel of the liquid crystal display device when a voltage is applied thereto;

FIG. 6 is a cross sectional view of one pixel of a liquid crystal display device as the second embodiment of the present invention;

FIG. 7 is a plan view of one pixel on one substrate of a liquid crystal display device as the third embodiment of the present invention;

FIG. 8 is a plan view showing a state of alignment of liquid crystal molecules in one pixel of the liquid crystal display device of the third embodiment when a voltage is applied thereto;

FIG. 9 is a plan view of one pixel on one substrate of a liquid crystal display device as the fourth embodiment of the present invention; and

FIG. 10 is a plan view showing a state of alignment of liquid crystal molecules in one pixel of the liquid crystal display device of the fourth embodiment when a voltage is applied thereto.

### DETAILED DESCRIPTION OF THE PREFERRED EMBODIMENTS

Liquid crystal display devices will be described below as embodiments of the present invention with reference to the accompanying drawings.

### First Embodiment

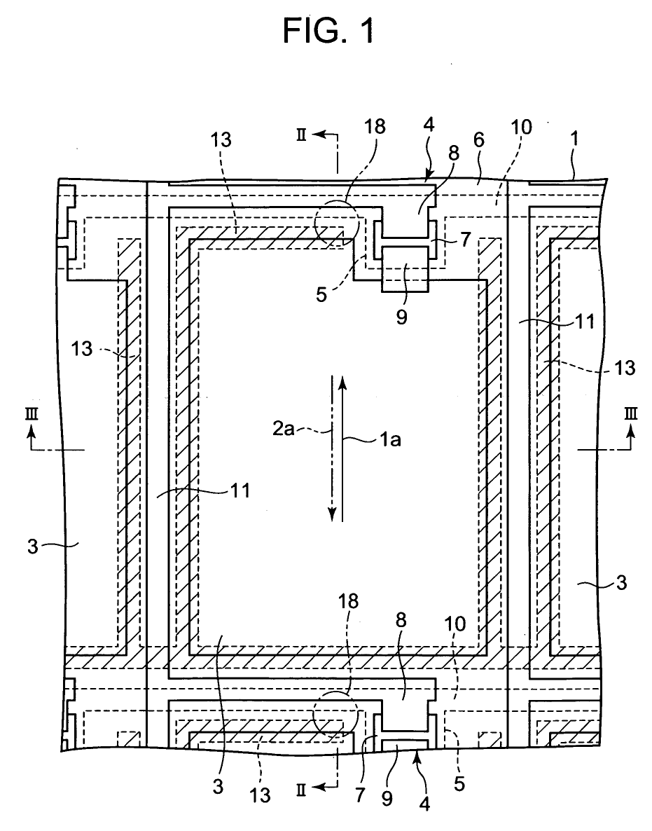

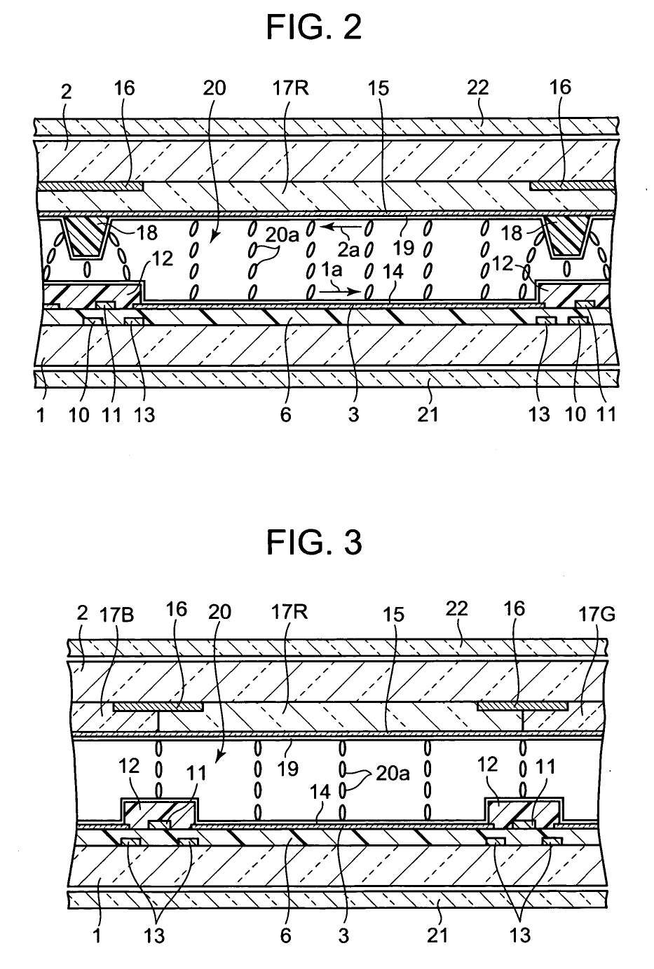

FIG. 1 to FIG. 5 show the first embodiment of the present invention, where FIG. 1 is a plan view of one pixel on one substrate of a liquid crystal display device, and FIG. 2 and FIG. 3 are cross sections of the liquid crystal display device of FIG. 1, as cut along the line II-II and the line III-III respectively.

The liquid crystal display device is a vertical alignment active matrix liquid crystal display device, and comprises a pair of transparent substrates 1 and 2 opposite to each other with a predetermined gap therebetween as shown in FIG. 1 to FIG. 3. At least one transparent opposing electrode 15 is formed on the inner surface of one substrate of the opposing inner surfaces of the pair of substrates 1 and 2, for example, on the inner surface of the substrate 2 on the viewer side (hereinafter referred to as front substrate). Formed on the inner surface of the other substrate of the opposing inner surfaces of the pair of substrates 1 and 2, i.e., on the inner surface of the substrate 1 counter to the display viewing position (hereinafter referred to as rear substrate) are a plurality of transparent pixel electrodes 3 arranged in a matrix of a row direction (left and right direction in FIG. 1) and a column direction (upward and downward direction in FIG. 1) to each define a pixel in the area where each faces the opposing electrode 15, a plurality of TFTs 4 formed correspondingly to the plurality of pixel electrodes 3 and connected to the corresponding pixel electrodes 3 respectively, and a plurality of gate lines 10 and data lines 11 formed between the rows of pixel electrodes and the columns of pixel electrodes to supply a gate signal and a data signal to the TFTs 4 on the corresponding rows and columns. Vertical alignment films 14 and 19 are formed on the inner surfaces of the pair of substrates 1 and 2 respectively, so as to cover the electrodes 3 and 15. A liquid crystal layer 20 having a negative dielectric anisotropy is filled in the gap between the pair of substrates 1 and 2.

The plurality of TFTs 4 comprise a gate electrode 5 formed on the surface of the rear substrate 1, a transparent gate insulation film 6 formed so as to cover the gate electrode 5 and extend over the entire region where the pixel electrode 3 is to be arranged, an i-type semiconductor film 7 formed on the gate insulation film 6 so as to be opposite to the gate electrode 5, and a drain electrode 8 and source electrode 9 formed on the one and the other edges of the i-type semiconductor film 7 via an unillustrated n-type semiconductor film.

The gate line 10 is formed on the surface of the rear substrate 1 integrally with the gate electrode 5 of the TFT 4, and the data line 11 is formed on the gate insulation film 6 integrally with the drain electrode 8 of the TFT 4.

The plurality of pixel electrodes 3 is formed on the gate insulation film 6 so as to have a shape of substantially a partially-cutaway rectangle whose opposing two edges, namely the edge (hereinafter referred to as one edge) adjoining the TFT 4 and the gate line 10 and the edge at the opposite side (hereinafter referred to as the other edge) counter to the one edge have a smaller length than that of the two side edges perpendicular to these edges (side edges parallel to the data line 11). The source electrode 9 of the TFT 4 extends over the gate insulation film 6 and is connected to the pixel electrode 3 at the cutaway portion of the one edge of the pixel electrode 3.

An auxiliary electrode 13 is further formed on the inner surface of the rear substrate 1 along the edges of each of the plurality of pixel electrodes 3 except at least a portion (TFT adjoining portion), which adjoins the TFT 4, of the one edge of the pixel electrode 3 that adjoins the TFT 4 and gate line 10, so as to face the opposing electrode 15 of the front substrate 2 at the periphery of the pixel electrode 3 to form a region (zero field region) in which substantially no electric field is applied between itself and the opposing electrode 15.

According to the present embodiment, the auxiliary electrode 13 is formed along almost all edges of the pixel electrode 3 to go generally the entire circumference of the pixel electrode except the TFT adjoining portion. In FIG. 1, the auxiliary electrode 13 is shown hatched for easier view.

The auxiliary electrode 13 also serves as a compensating-capacitor electrode which forms a compensating capacity between itself and the pixel electrode 3.

The auxiliary electrode 13 is formed of a frame-shaped metal film provided on the surface of the rear substrate 1 along the circumference of the pixel electrode 3 except the TFT adjoining portion. Each side of the frame-shaped metal film has its inner edge face one of the edges of the pixel electrode 3 via the gate insulation film 6 and has its outer edge form a width by extending away from the pixel electrode 3.

The inner edges of the sides of the frame-shaped metal film constitute a capacitor electrode which forms a compensating capacity between the inner edges and the circumference of the pixel electrode 3 while the gate insulation film 6 serves as a dielectric layer. The outer edges of the sides of the frame-shaped metal film, i.e., the portions extending away from the pixel electrode 3 face the opposing electrode 15 and constitute an auxiliary electrode portion that forms a region to which no electric field is applied between itself and the opposing electrode 15. That is, the auxiliary electrode 13 comprises a capacitor electrode portion and an auxiliary electrode portion, and these capacitor electrode portion and auxiliary electrode portion are formed integrally.

The auxiliary electrodes 13 corresponding to the circumference of the plurality of pixel electrodes 3 respectively are jointed to each other per row of pixel electrodes at one edge of the pixel electrode 3 that is opposite to the TFT adjoining edge. The auxiliary electrodes 13 on each row are connected in common to an unillustrated auxiliary electrode connection line which is provided in parallel with the data line 11 at one outer edge or both outer edges of the region where the pixel electrode 3 is arranged.

Further, an overcoat insulation film 12 which covers the plurality of TFTs 4 and the data lines 11 but not the plurality of pixel electrodes 3 is formed on the inner surface of the rear substrate 1, and a second vertical alignment film 14 that covers the pixel electrodes 3 is formed on the overcoat insulation film 12.

On the other hand, formed on the inner surface of the front substrate 2 are a latticed black mask 16 which faces the regions between the plurality of pixels corresponding to the plurality of pixel electrodes 3 formed on the inner surface of the rear substrate 1, and color filters 17R, 17G, and 17B having three colors of red, green, and blue that correspond to the plurality of pixels respectively. The opposing electrode 15 is formed on the color filters 17R, 17G, and 17B.

A plurality of protrusions 18 made of a dielectric material having insulativity are further formed on the inner surface of the front substrate 2 at a portion corresponding to a portion of the rear substrate 1 about the center of either one of the one edge of each of the plurality of pixel electrodes 3 that adjoins the TFT 4 and gate line 10 and the other edge opposite to the one edge. According to the present embodiment, the plurality of protrusions 18 are formed correspondingly to the portion about the center of the one edge of each of the plurality of pixel electrodes 3 that adjoins the TFT 4 and gate line 10.

The plurality of protrusions 18 are formed in a shape of, for example, a truncated cone having its diameter decreasing toward its top. The protrusions 18 have their part positioned so as to face the one edge of the pixel electrodes 3, the gate line 10, and the data line 11.

According to the present embodiment, the truncated-conic protrusions 18 are positioned such that their conic base contacting the opposing electrode 15 corresponds, at one part of its circumference, to the interior of the pixel electrode 3, and the slanted circumferential surface of the protrusions 18 partly faces an edge of the pixel electrode 3. The protrusions 18 are covered and hidden by the black mask 16 formed on the inner surface of the front substrate 2.

The plurality of protrusions 18 are formed on the opposing electrode 15 by using an insulative material such as a photosensitive resin, and a first vertical alignment film 19 is formed so as to cover the opposing electrode 15 and the protrusions 18.

The first vertical alignment film 19 on the inner surface of the front substrate 2 is rubbed substantially parallel to the side edges of the pixel electrode 3 in a direction 2a that heads from the one edge of the pixel electrode 3 corresponding to the protrusion 18 toward the other edge opposite to the one edge. The second vertical alignment film 14 on the inner surface of the rear substrate 1 is rubbed substantially parallel to the side edges of the pixel electrode 3 in a direction 1a reverse to the rubbing direction 2a of the first vertical alignment film 19, i.e, a direction 1a that heads from the other edge of the pixel electrode 3 opposite to the one edge corresponding to the protrusion 18 toward the one edge. In FIG. 1 and FIG. 2, the arrow 1a indicates the rubbing direction of the second vertical alignment film 14 on the rear substrate 1, and the arrow 2a indicates the rubbing direction of the first vertical alignment film 19 on the front substrate 2.

The rear substrate 1 and the front substrate 2 are jointed to each other via an unillustrated frame-shaped sealing member that surrounds the regions where the plurality of pixel electrodes 3 are arranged.

The rear substrate 1 has, though not illustrated, led-out portions which are led out toward the outside of the front substrate 2, at one end of the row direction and one end of the column direction respectively. A plurality of gate driver connection terminals are arranged on the led-out portion of the row direction, and a plurality of data driver connection terminals are arranged on the led-out portion of the column direction.

The plurality of gate lines 10 are led toward the led-out portion of the row direction to be connected to the plurality of gate driver connection terminals. The plurality of data lines 11 are led toward the led-out portion of the column direction to be connected to the plurality of data driver connection terminals. The auxiliary electrode connection line is led toward one or both of the led-out portions of the row and column directions to be connected to an electric potential supply terminal which supplies a predetermined electric potential, of the plurality of driver connection terminals on that led-out portion.

Furthermore, an opposing electrode connection line is formed on the inner surface of the rear substrate 1 so as to be led from near a corner of the substrate-jointed portion where the substrates are jointed by the sealing member toward one or both of the led-out portions of the row and column directions to be connected to the electric potential supply terminal of the driver connection terminals. The opposing electrode 15 formed on the inner surface of the front substrate 2 is connected, at the substrate-jointed portion, to the opposing electrode connection line and further to the electric potential supply terminal through the opposing electrode connection line.

That is, according to the present embodiment, the electric potential of the plurality of auxiliary electrode 13 is made equal to that of the opposing electrode 15, thereby forming a region to which substantially no electric field is applied, between the auxiliary electrodes 13 and the opposing electrode 15.

The liquid crystal layer 20 is filled in the region surrounded by the sealing member between the rear substrate 1 and front substrate 2, and the liquid crystal molecules 20a of the liquid crystal layer 20 are aligned generally perpendicularly to the surfaces of the vertical alignment films. That is, the liquid crystal molecules 20a are, except in the regions corresponding to the protrusions 18, aligned substantially perpendicularly to the rear and front substrates 1 and 2 due to the vertical aligning property of the vertical alignment films 14 and 19 formed on the inner surfaces of the substrates 1 and 2 while slightly tilting in the rubbing directions of the vertical alignment films 14 and 19. In the regions corresponding to the protrusions 18, the liquid crystal molecules 20a around the protrusions 18 on the front substrate 2 are aligned with the molecular long axis tilting in a direction substantially perpendicular to the circumferential surface and end surface of the protrusions 18, and the liquid crystal molecules 20a closer to the rear substrate 1 are aligned substantially perpendicularly to the rear substrate 1 in the same tilting state as that occurring in the other regions than the regions corresponding to the protrusions 18.

Polarizing plates 21 and 22 are disposed on the external surfaces of the rear substrate 1 and front substrate 2 respectively, with their transmission axes aligned in predetermined directions. According to the present embodiment, the transmission axes of the polarizing plates 21 and 22 are aligned so as to be substantially orthogonal to each other, so as to permit the liquid crystal display device to perform display of a normally black mode.

The present liquid crystal display device displays images by aligning the liquid crystal molecules 20a to lie down from the vertically aligned state, by applying a voltage between the pixel electrode 3 and the opposing electrode 15 in each of the plurality of pixels. The liquid crystal molecules 20a are aligned substantially vertically in the regions between the pixels, to which the voltage is not applied. The liquid crystal molecules 20a are aligned into lying alignment in accordance with the voltage applied, in each pixel.

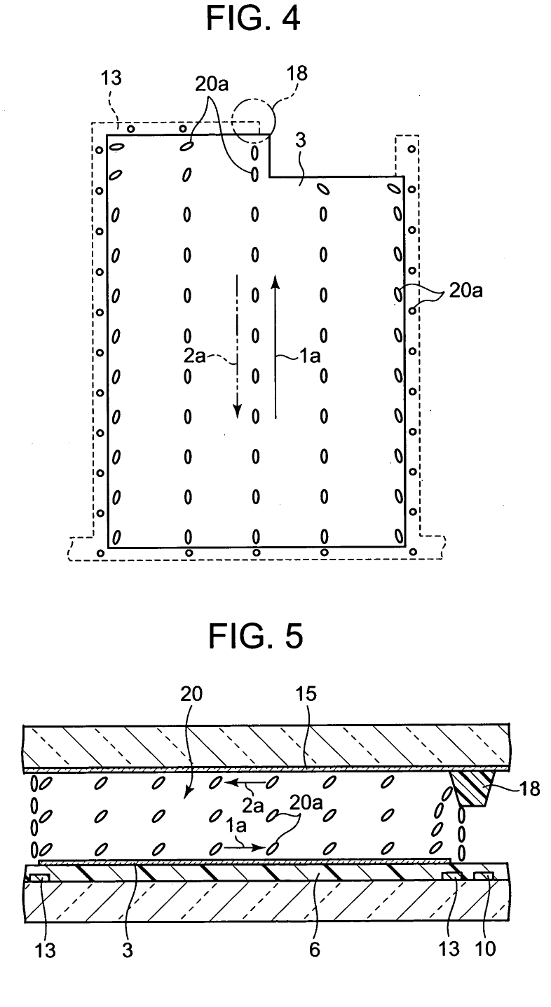

FIG. 4 and FIG. 5 are a plan view and cross sectional view exemplarily showing the state of alignment of the liquid crystal molecules in one pixel of the liquid crystal display device when a voltage is applied. The present liquid crystal display device is provided with the plurality of protrusions 18 each positioned correspondingly to the position about the center of the one edge of each of the plurality of pixel electrodes 3 on the inner surface of the rear substrate 1, and has its first vertical alignment film 19 on the inner surface of the front substrate 2 rubbed in the direction from the one edge of the pixel electrode 3 that positionally corresponds to the protrusion 18 toward the other edge opposite to the one edge while having its second vertical alignment film 14 on the inner surface of the rear substrate 1 rubbed in the direction reverse to the rubbing direction of the first vertical alignment film 19, thereby defining the lying directions of the liquid crystal molecules 20a in each pixel to the rubbing directions of the vertical alignment films 14 and 19 and to the liquid crystal molecule aligning direction around the protrusions 18 and allowing display of high-quality images with the aligning direction in each pixel stabilized.

For example, in case of a liquid crystal display device (not shown) provided with no protrusions and having the vertical alignment films 14 and 19 un-rubbed, the liquid crystal molecules in each pixel lie down radially inward from the periphery of the pixel in response to a voltage applied. However, the center toward which the molecules lie down radially is unstable, bringing the liquid crystal molecules in each pixel into varied states of lying alignment and making the viewer feel display roughness.

In contrast, a liquid crystal display device as taught by the present invention in which the protrusions 18 are provided and the vertical alignment films 14 and 19 are rubbed, has the protrusions 18 provided on the inner surface of the front substrate 2 correspondingly to the position about the center of the one edge of each pixel electrode 3 on the rear substrate 1, thereby aligns the liquid crystal molecules 20a near the protrusions 18 in a direction substantially perpendicular to the circumferential surface of the protrusions 18, which in turn influences the liquid crystal molecules 20a surrounding the molecules 20a near the protrusions 18 to be aligned so as to lie down toward the protrusions 18. Besides, the second vertical alignment film 14 and the first vertical alignment film 19 which are flat and rubbed in opposite directions to each other make the liquid crystal molecules 20a in each pixel aligned toward the protrusions 18 as shown in FIG. 4 and FIG. 5 in response to the voltage applied, making the aligning directions over generally the entire region of a pixel averaged substantially in one direction.

Hence, the liquid crystal display device can have a stable alignment state of the liquid crystal molecules 20a in each pixel and can display a high-quality image with no roughness.

In order to prevent occurrence of a gap between the protrusions 18 and the one edge of the pixel electrodes 3 corresponding to the protrusions 18 to which gap no electric field would be applied and thereby to prevent the liquid crystal display device from losing the influence of the protrusions 18 given on the alignment of the liquid crystal molecules 20a above each pixel electrode 3, the plurality of protrusions 18 are provided such that their part faces the one edge of the pixel electrodes 3 formed on the other substrate.

Further, since the liquid crystal display device has the plurality of protrusions 18 provided correspondingly to the position about the center of the one edge of the pixel electrodes 3 that adjoins the TFT 4 and the gate line 10, the protrusions 18 can cover and hide any disorders in the alignment of the liquid crystal molecules 20a occurring around the edge of each pixel due to influences of an electric field generated between the gate line 10 and the pixel electrode 3.

The liquid crystal display device is further provided, on the inner surface of the rear substrate 1 along the pixel electrode 3 except at least the TFT adjoining portion of the edge of the pixel electrode 3 that adjoins the TFT 4, with the auxiliary electrode 13 which faces the opposing electrode 15 on the front substrate 2 to form a region to which substantially no electric field is applied between itself and the opposing electrode 15 in substantially the peripheral region surrounding the pixel electrode 3. Thus, the liquid crystal molecules 20a in the region where the auxiliary electrode 13 and the opposing electrode 15 face each other are aligned substantially vertically as shown in FIG. 4 and FIG. 5, and the liquid crystal molecules 20a in each pixel can securely be aligned to lie down inward from the periphery.

According to the present embodiment, since the auxiliary electrode 13 is formed along all the edges of the pixel electrode 3 around the entire circumference of the pixel electrode 3 except the TFT adjoining portion, the liquid crystal molecules 20a are free from aligning disorderly near an edge of the pixel that sides the data line 11 due to the influences of a data signal, making it possible to obtain a stable state of alignment of the liquid crystal molecules 20a in each pixel.

Furthermore, since the liquid crystal display device has the auxiliary electrode 13 formed integrally with a compensating-capacitor electrode for forming a compensating capacity between itself and the pixel electrode 3, it is possible to increase the area of the pixel electrode 3 with a simple structure and to obtain a sufficient aperture ratio.

### Second Embodiment

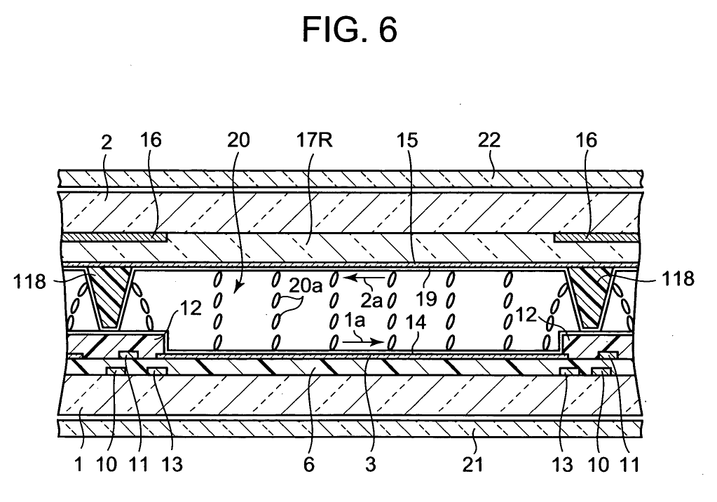

FIG. 6 is a cross sectional view of one pixel of a liquid crystal display device as the second embodiment of the present invention. In the present embodiment, the components same as those in the first embodiment will be given the same reference numerals, and explanation for such components will be omitted.

The liquid crystal display device according to the present embodiment has a plurality of protrusions 118 on the inner surface of the front substrate 2 formed to have a predetermined height of protrusion for setting the thickness of the liquid crystal layer to a predetermined one, and has the end of the plurality of protrusions 118 abut on the inner surface of the rear substrate 1 (abut on the overcoat insulation film 12 between the plurality of pixel electrodes 3), thereby defining the gap between the pair of substrates 1 and 2. The structure of the liquid crystal display device of the present invention is the same as that of the liquid crystal display device of the first embodiment in the other respects.

To be more specific, the present liquid crystal display device has the plurality of protrusions 118 serve also as the spacers for defining the gap between the pair of substrates 1 and 2. This structure makes the liquid crystal layer thickness in each pixel uniform, enabling a high-quality image with no luminance unevenness to be displayed and the liquid crystal display device to be manufactured with more ease.

### Third Embodiment

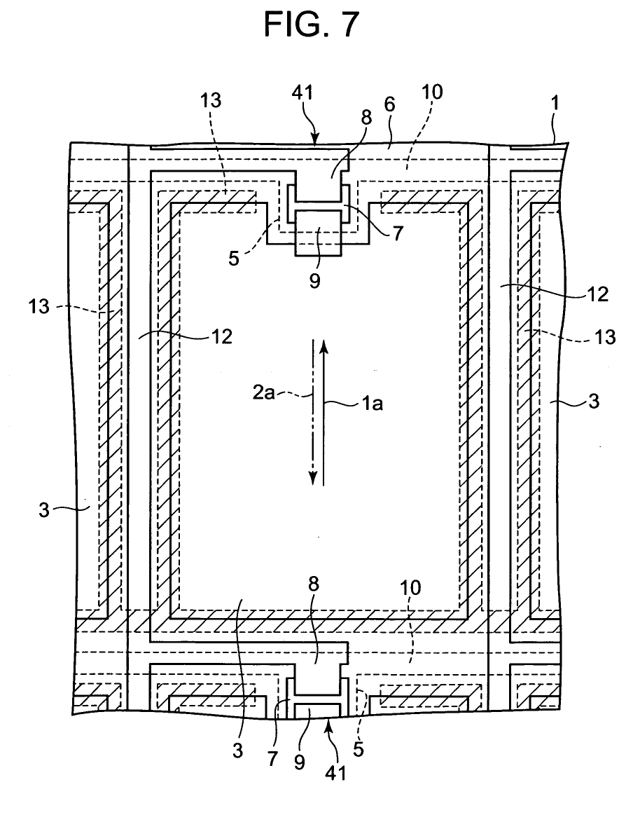

FIG. 7 is a plan view of one pixel on one substrate of a liquid crystal display device as the third embodiment of the present invention. In the present embodiment, the components same as those in the first embodiment will be given the same reference numerals, and explanation for such components will be omitted.

The liquid crystal display device according to the present embodiment is not provided with the plurality of protrusions 18 that are provided on the inner surface of the front substrate 2 according to the first embodiment, but has the thin film transistors (TFTs) function as the protrusions 18 in order to stabilize the state of alignment of the liquid crystal molecules by the gate field of the TFTs and the electric field generated between the pixel electrodes 3. Hence, the present liquid crystal display device has each of a plurality of TFTs 41 on the inner surface of the rear substrate 1 positioned at about the center of one edge of each of the pixel electrodes 3, and has the first vertical alignment film 19 on the inner surface of the front substrate 2 on which the opposing electrode 15 is formed rubbed in a direction 2a that heads from the one edge of the pixel electrode 3 to which the thin film transistor 41 is connected toward the other edge opposite to the one edge, while having the second vertical alignment film 14 on the inner surface of the rear substrate 1 on which the plurality of pixel electrodes 3 and the TFTs 41 are formed rubbed in a direction 1a reverse to the rubbing direction of the first vertical alignment film 19.

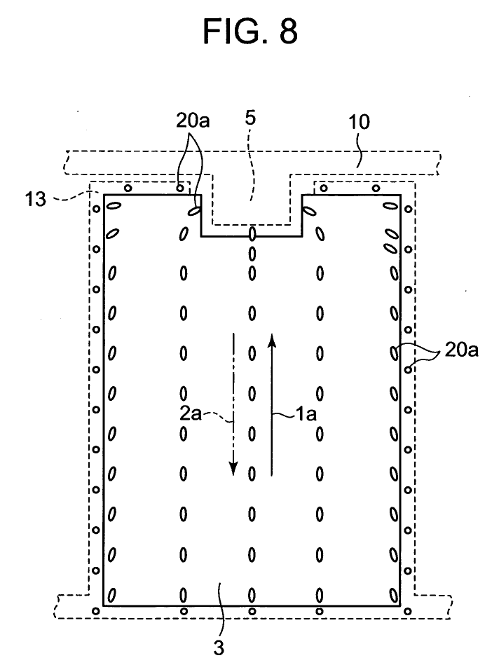

FIG. 8 is a plan view exemplarily showing the state of alignment of liquid crystal molecules in one pixel of the liquid crystal display device according to the present embodiment, when a voltage is applied. Since the liquid crystal display device has each of the plurality of TFTs 41 positioned at about the center of the one edge of each of the plurality of pixel electrodes 3 and has the vertical alignment films 14 and 19 on the pair of substrates 1 and 2 rubbed in the above-described directions, the liquid crystal molecules 20a near the TFT 41 are aligned obliquely in accordance with differences in level at the TFT 41, whereas the liquid crystal molecules 20a in each pixel are, when a voltage is applied between the pixel electrode 3 and the opposing electrode 15, regulated so as to be in a orderly lying alignment in the rubbing directions of the vertical alignment films 14 and 19 and in a liquid crystal molecule aligning direction which is due to a lateral field (an electric field corresponding to a gate signal) generated between the gate electrode 5 of the TFT 41 and the pixel electrode 3, thereby enabling a high-quality image to be displayed.

That is, since the liquid crystal display device according to the present embodiment has the TFT 41 positioned at about the center of the one edge of the pixel electrode 3, the liquid crystal molecules 20a near an edge of each pixel that adjoins the TFT 41 are influenced by a strong lateral field generated between the gate electrode 5 of the TFT 41 and the pixel electrode 3 in response to a gate signal, thereby to be in a lying alignment along the direction of the lateral field, when a voltage is applied between the electrodes 3 and 15 in each pixel.

The second vertical alignment film 14 on the inner surface of the rear substrate 1 is rubbed in a direction that heads from the other edge of the pixel electrode 3 that is opposite to the one edge thereof adjoining the TFT 41 and gate line 10 toward the one edge adjoining the TFT 41 and gate line 10. Since this rubbing direction and the direction of lying alignment of the liquid crystal molecules 20a near the center (TFT adjoining portion) of the one edge due to the lateral field are substantially the same as each other, the liquid crystal molecules 20a in each pixel are aligned in the direction toward the one edge over almost the entire region of the pixel as shown in FIG. 8, when a voltage is applied.

That is, the liquid crystal molecules 20a in each pixel are aligned so as to lie down toward the TFT 41 positioned at about the center of the one edge of the pixel electrode 3 when a voltage is applied, and the liquid crystal display device according to the present embodiment has the liquid crystal molecules 20a in each pixel aligned in substantially one lying alignment direction in each pixel thereby obtaining a stable alignment state of the liquid crystal molecules 20a in each pixel and enabling a high-quality image with no feel of roughness to be displayed.

The present liquid crystal display device is also provided, on the inner surface of the rear substrate 1 along generally the entire circumference of each of the plurality of pixel electrode 3 except the TFT adjoining portion of the one edge of the pixel electrode 3 that adjoins the TFT 41, with the auxiliary electrode 13 that faces the opposing electrode 15 of the front substrate 2 and forms a region in which no electric field is generated between itself and the opposing electrode 15. Thus, the liquid crystal molecules 20a in the region where the auxiliary electrode 13 and the opposing electrode 15 face each other are substantially vertically aligned, whereas the liquid crystal molecules 20a in each pixel can be securely aligned to lie inward from the periphery when a voltage is applied.

According to the present embodiment, since the auxiliary electrode 13 is formed along all the edges of the pixel electrode 3 around the entire circumference of the pixel electrode 3 except the TFT adjoining portion, the liquid crystal molecules 20a are free from aligning disorderly near an edge of the pixel that sides the data line 11 due to the influences of a data signal, making it possible to obtain a stable state of alignment of the liquid crystal molecules 20a in each pixel.

Furthermore, since the liquid crystal display device has the auxiliary electrode 13 formed integrally with a capacitor electrode for forming a compensating capacity between itself and the pixel electrode 3, a sufficient aperture ratio can be obtained.

### Fourth Embodiment

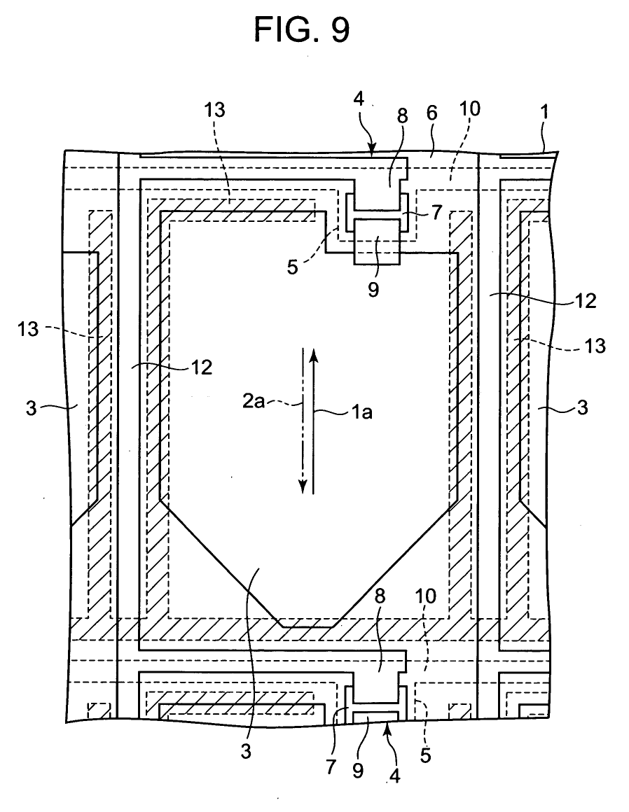

FIG. 9 is a plan view of one pixel on one substrate of a liquid crystal display device as the fourth embodiment of the present invention. In the present embodiment, the components same as those in the first embodiment will be given the same reference numerals, and explanation for such components will be omitted.

The liquid crystal display device according to the present embodiment is not provided with the plurality of protrusions 18 that are formed on the inner surface of the front substrate 2 according to the first embodiment, has each of the plurality of pixel electrodes 3 formed to have a V-letter-shaped edge obtained by obliquely cutting one of the two opposing edges of the rectangle forming the pixel electrode 3 obliquely from the center of the edge toward both sides, has the TFTs 4 positioned at one side of one edge of the pixel electrode 3 that is opposite to the V-shaped edge, and has the second vertical alignment film 14 on the inner surface of the rear substrate 1 on which the plurality of pixel electrodes 3 and the TFTs 4 are formed rubbed in a direction 1a that heads from the V-shaped edge of the pixel electrode 3 toward the one edge thereof, while having the first vertical alignment film 19 on the inner surface of the front substrate 2 on which the opposing electrode 15 is formed rubbed in a direction 2a reverse to the rubbing direction 1a of the second vertical alignment film 14.

According to the present embodiment, the V-shaped edge of the pixel electrode 3 is formed such that its center portion is parallel to the opposite edge of the pixel electrode 3, i.e., parallel to the one edge adjoining the TFT 4 and the gate line 10, and both of its side portions are inclined toward the opposite edge.

According to the present embodiment, the inclining portions at both sides of the V-shaped edge of the pixel electrode 3 are inclined with respect to the rubbing directions 1a and 2a of the vertical alignment films 14 and 19 at an inclination angle of 45°±15° respectively. The inclination angle of the inclining portions at both sides of the V-shaped edge is preferably 45°±10°, and more preferably 45°±5°.

Since the present liquid crystal display device has the edge of each of the plurality of pixel electrodes 3 that is opposite to the edge adjoining the TFT 4 and the gate line 10 formed to be a V-shaped edge having a V-letter shape that inclines from the center to both sides toward the opposite edge, and has the second vertical alignment film 14 on the inner surface of the rear substrate 1 on which the plurality of pixel electrodes 3 and the TFTs 4 are formed rubbed in a direction heading from the V-shaped edge of the pixel electrode 3 toward the opposite edge, the liquid crystal molecules 20a in each pixel are, when a voltage is applied between the pixel electrode 3 and the opposing electrode 15, regulated in the rubbing directions of the vertical alignment films 14 and 19 and in a liquid crystal molecule aligning direction near the V-shaped edge of the pixel electrode 3, thereby stabilizing the alignment state and enabling a high-quality image to be displayed.

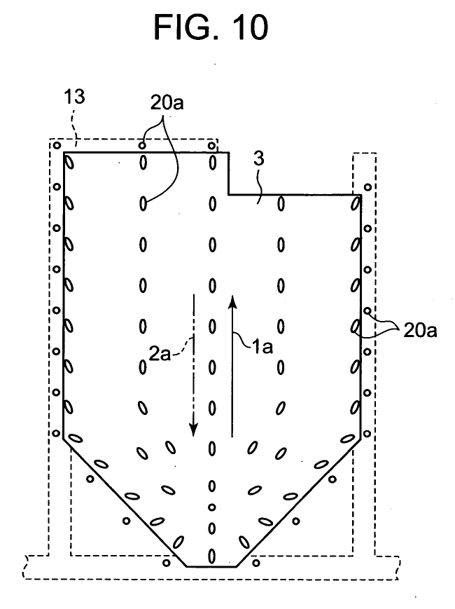

FIG. 10 is a plan view exemplarily showing the state of alignment of the liquid crystal molecules in on pixel of the liquid crystal display device when a voltage is applied. When a voltage is applied, the liquid crystal molecules 20a in each pixel start to lie down inward from the peripheral portion of the pixel. At the V-shaped edge of the pixel electrode 3, the liquid crystal molecules 20a come lying down from the surrounding region in a limited area, thereby forming the center of alignment at a position inside the V-shaped edge and not far away from the V-shaped edge and making the liquid crystal molecules 20a aligned radially from this center of alignment.

According to the present embodiment, since the inclination angle of the inclining portions at both sides of the V-shaped edge of the pixel electrode 3 with respect to the rubbing directions 1a and 2a of the vertical alignment films 14 and 19 is set to 45°±15°, it is possible to more securely define the lying direction of the liquid crystal molecules 20a in each pixel when a voltage is applied.

The inclination angle of the inclining portions at both sides of the V-shaped edge is preferably 45°±10°, and more preferably 45°±5°. The more the inclination angle approaches 45°, the more securely the lying direction of the liquid crystal molecules 20a in each pixel can be regulated.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-375019 filed on Dec. 24, 2004 and including specification, claims, drawings and summary. The disclosure of the above Japanese Patent Application is incorporated herein by reference in its entirety.

What is claimed is:

1. A liquid crystal display device, comprising:
a pair of substrates which are opposite to each other with a predetermined gap therebetween;
at least one opposing electrode which is formed on an inner surface of one substrate of opposing inner surfaces of the pair of substrates;
a plurality of pixel electrodes which are arranged in a matrix of a row direction and a column direction on an inner surface of the other substrate of the opposing inner surfaces of the pair of substrates, each define a pixel in an area where each faces the opposing electrode, and each have a shape of substantially a rectangle;
a plurality of protrusions which are formed on the inner surface of either one substrate of the pair of substrates so as to each adjoin one edge, which is one of two opposing edges of each of the plurality of pixel electrodes, and so as to correspond to a position about a center of length of the one edge;
a first vertical alignment film which is formed on the inner surface of the one substrate and rubbed in a direction heading from the one edge of the pixel electrode adjoining the protrusion toward the other edge opposite to the one edge;
a second vertical alignment film which is formed on the inner surface of the other substrate and rubbed in a direction reverse to the rubbing direction of the first vertical alignment film; and
a liquid crystal layer which is filled in the gap between the pair of substrates and has a negative dielectric anisotropy.

2. The liquid crystal display device according to claim 1, wherein the plurality of protrusions are formed on the inner surface of one substrate on which the opposing electrode is formed.

3. The liquid crystal display device according to claim 2, wherein:
the first vertical alignment film is formed so as to cover the opposing electrode and the protrusions which are formed on the inner surface of the one substrate, and is rubbed in a direction heading from the one edge of the pixel electrode formed on the other substrate that adjoins the protrusion toward the other edge opposite to the one edge; and
the second vertical alignment film is formed so as to cover the plurality of pixel electrodes formed on the inner surface of the other substrate, and is rubbed in a direction reverse to the rubbing direction of the first vertical alignment film.

4. The liquid crystal display device according to claim 1, wherein
the plurality of protrusions are each formed so as to have their one part face the one edge of each of the plurality of pixel electrodes formed on the other substrate.

5. The liquid crystal display device according to claim 1, wherein
the protrusions are made of a dielectric material.

6. The liquid crystal display device according to claim 1, further comprising:
a plurality of thin film transistors which are formed on the inner surface of the other substrate so as to correspond to the plurality of pixel electrodes respectively, and are connected to the corresponding pixel electrodes respectively; and
a plurality of gate lines and data lines which are formed between rows and columns of the plurality of pixel electrodes respectively, for supplying a gate signal and a data signal to the thin film transistors on the corresponding rows and columns.

7. The liquid crystal display device according to claim 6, wherein
the protrusions are each formed on the inner surface of the one substrate at a position which adjoins the one edge, to which the thin film transistor is connected, of each of the plurality of pixel electrodes, and which corresponds to the position about the center of length of the one edge.

8. The liquid crystal display device according to claim 1, wherein
the plurality of protrusions have a height of protrusion for setting a liquid crystal layer thickness to a predetermined thickness, and the gap between the pair of substrates is defined by ends of the plurality of protrusions abutting on the inner surface of the other substrate.

9. The liquid crystal display device according to claim 1, further comprising
an auxiliary electrode which is formed on the inner surface of the other substrate along edges of each of the plurality of pixel electrodes except a portion of the one edge adjoining the thin film transistor in a peripheral region of the pixel electrode, in order to form a region between the auxiliary electrode and the opposing electrode on the one substrate to which region substantially no electric field is applied.

10. The liquid crystal display device according to claim 9, wherein
the auxiliary electrode is formed integrally with a compensating-capacitor electrode for forming a compensating capacity between the compensating-capacitor electrode and the pixel electrode.

11. The liquid crystal display device according to claim 1, wherein
a plurality of thin film transistors are formed on the inner surface of the other substrate so as to correspond to the plurality of pixel electrodes respectively and so as to be connected to the corresponding pixel electrodes respectively, wherein the thin film transistors are each formed on a position about a center of the one edge of each of the plurality of pixel electrodes.

12. The liquid crystal display device according to claim 11, wherein:
the first vertical alignment film is formed on the inner surface of the one substrate so as to cover the opposing electrode and is rubbed in a direction heading from the one edge, to which the thin film transistor is connected, of the pixel electrode formed on the other substrate toward the other edge opposite to the one edge; and
the second vertical alignment film is formed on the inner surface of the other substrate so as to cover the plurality of pixel electrodes and the plurality of thin film transistors, and is rubbed in a direction reverse to the rubbing direction of the first vertical alignment film.

13. A liquid crystal display device, comprising:
a pair of substrates which are opposite to each other with a predetermined gap therebetween;
at least one opposing electrode which is formed on an inner surface of one substrate of opposing inner surfaces of the pair of substrates;
a plurality of pixel electrodes which are formed in a matrix of a row direction and a column directions on an inner surface of the other substrate of the opposing inner surfaces of the pair of substrates, and each define a pixel in an area where each faces the opposing electrode;
a plurality of thin film transistors which are formed on the inner surface of the other substrate so as to correspond to the plurality of pixel electrodes respectively, and are connected to the corresponding pixel electrodes respectively;
a plurality of gate lines and data lines which are formed on the inner surface of the other substrate between rows and columns of the plurality of pixel electrodes, for supplying a gate signal and a data signal to the thin film transistors on the corresponding rows and columns;
a plurality of protrusions which are each formed on the inner surface of the one substrate at a position which adjoins either of one edge, to which the thin film transistor is connected, of each of the plurality of pixel electrodes and the other edge opposite to the one edge, and which position corresponds to a position about a center of length of the either of the edges;
a first vertical alignment film which is formed on the inner surface of the one substrate so as to cover the opposing electrode and the protrusions, and is rubbed in a direction heading from the one edge, which adjoins the protrusion, of the pixel electrode formed on the other substrate toward the other edge opposite to the one edge;
a second vertical alignment film which is formed on the inner surface of the other substrate so as to cover the plurality of pixel electrodes, and is rubbed in a direction reverse to the rubbing direction of the first vertical alignment film; and
a liquid crystal layer which is filled in the gap between the pair of substrates and has a negative dielectric anisotropy.

14. The liquid crystal display device according to claim 13, wherein
the pixel electrode is formed in a shape of a rectangle; and
the plurality of protrusions are each formed on the inner surface of the one substrate at a position which adjoins the one edge, to which the thin film transistor is connected, of each of the plurality of pixel electrodes on the other substrate, and which position corresponds to a position about the center of length of the one edge.

15. The liquid crystal display device according to claim 14, wherein
the protrusions are each formed at a position at which part of each protrusion overlaps the gate line formed between rows of a plurality of pixel electrodes and the one edge of the pixel electrode.

16. The liquid crystal display device according to claim 13, wherein
the plurality of protrusions have a height of protrusion for setting a liquid crystal layer thickness to a predetermined thickness, and the gap between the pair of substrates is defined by ends of the plurality of protrusions abutting on the inner surface of the other substrate.

17. The liquid crystal display device according to claim 13, further comprising
an auxiliary electrode which is formed on the inner surface of the other substrate along edges of each of the plurality of pixel electrodes except a portion of the one edge adjoining the thin film transistor in a peripheral region of the pixel electrode, in order to form a region between the auxiliary electrode and the opposing electrode on the one substrate to which region substantially no electric field is applied.

18. The liquid crystal display device according to claim 17, wherein
the auxiliary electrode is formed integrally with a compensating-capacitor electrode for forming a compensating capacity between the compensating-capacitor electrode and the pixel electrode.

19. A liquid crystal display device, comprising:
a pair of substrates which are opposite to each other with a predetermined gap therebetween;
at least one opposing electrode which is formed on an inner surface of one substrate of opposing inner surfaces of the pair of substrates;
a plurality of pixel electrodes which are formed in a matrix of a row direction and a column direction on an inner surface of the other substrate of the opposing inner surfaces of the pair of substrates, which each have a shape of a rectangle having one edge of its two opposing edges formed to be a V-shaped edge having substantially a V-character shape obtained by obliquely cutting the one edge from a center of the one edge toward both sides, and which each define a pixel in an area where each faces the opposing electrode;
a plurality of thin film transistors which are each formed on the inner surface of the other substrate so as to correspond to the other edge of each of the plurality of pixel electrodes that is opposite to the V-shaped edge, and which are each connected to the corresponding pixel electrode;
a plurality of gate lines and data lines which are formed on the inner surface of the other substrate between rows and columns of the plurality of pixel electrodes, for supplying a gate signal and a data signal to the thin film transistors on the corresponding rows and columns;
a first vertical alignment film which is formed on the inner surface of the one substrate so as to form the opposing electrode and is rubbed in a direction heading from the other edge opposite to the V-shaped edge of the pixel electrode formed on the other substrate toward the V-shaped edge;
a second vertical alignment film which is formed on the inner surface of the other substrate so as to cover the plurality of pixel electrodes, and is rubbed in a direction reverse to the rubbing direction of the first vertical alignment film; and
a liquid crystal layer which is filled in the gap between the pair of substrates and has a negative dielectric anisotropy.

20. The liquid crystal display device according to claim 19, wherein
edge portions on the both sides of the V-shaped edge of the pixel electrode are formed to be inclined with respect to the rubbing directions of the first and second vertical alignment films at an angle of 45°±15°, respectively.
